(19) United States
(12) Patent Application Publication
(10) Pub. No.: US 2023/0334576 A1
(43) Pub. Date: Oct. 19, 2023

(54) SYSTEM ARCHITECTURE FOR A DIGITAL PLATFORM

(71) Applicant: FINRESULTS, INC., Boca Raton, FL (US)

(72) Inventor: Michael Wesley Andrud, Boca Raton, FL (US)

(21) Appl. No.: 18/134,133

(22) Filed: Apr. 13, 2023

Related U.S. Application Data
(60) Provisional application No. 63/330,690, filed on Apr. 13, 2022.

(51) Int. Cl. G06Q 40/06; G06Q 50/18

(52) U.S. Cl. CPC G06Q 40/06; G06Q 50/18

(57) ABSTRACT

Various embodiments of the present disclosure include a method for servicing a client account. In some embodiments, the method can include receiving information from the client. In some embodiments, the method can include determining a characteristic associated with the information. In some embodiments, the method can include determining a reactive response to the information, based on the characteristic associated with the information, using artificial intelligence, wherein the reactive response includes presenting a prompt to the user, and wherein the prompt is a prompt that requests additional information from the user specific to the determined characteristic.

### BACKGROUND

### a. Field

This disclosure relates to a system architecture for a digital platform.

### b. Background Art

The cannabis banking industry is highly regulated and comes with many compliance requirements. While banking in the cannabis industry can be very lucrative, the compliance requirements associated with the industry can prove to be a barrier to entry for some banks and make the industry less appealing to other banks. While transactions on a federal level are still considered illegal, transactions made on some state levels are legal. Currently the number of systems that support the cannabis banking industry are limited. In some states where the transactions are legal, systems that are used for banking in the cannabis industry involve time-consuming manual processes and disparate systems that each support one of onboarding, compliance monitoring, and risk management. As a result of the time-consuming manual processes and the disparate systems that are presently used for banking in the cannabis industry, greater onboarding time for customers and greater servicing costs are associated with banking in the cannabis industry. Embodiments of the present disclosure can provide solutions to at least the problems set forth above.

### SUMMARY

Various embodiments of the present disclosure include a method receiving information from the client. In some embodiments, the method can include determining a characteristic associated with the information. In some embodiments, the method can include determining a reactive response to the information, based on the characteristic associated with the information, using artificial intelligence, wherein the reactive response includes presenting a prompt to the user, and wherein the prompt is a prompt that requests additional information from the user specific to the determined characteristic.

Various embodiments of the present disclosure include a method for servicing a client account. In some embodiments, the method can include receiving information from the client. In some embodiments, the method can include determining a characteristic associated with the information, wherein the characteristic relates to an ownership interest in a company. In some embodiments, the method can include determining a reactive response to the information, based on the characteristic associated with the information, using artificial intelligence, wherein the reactive response includes presenting a prompt to the user, and wherein the prompt is a prompt that requests additional information from the user specific to the determined characteristic.

Various embodiments of the present disclosure include a non-transitory computer-readable medium storing instructions to service a client account. In some embodiments, the instructions can be executed to request information from a user, wherein the information requested includes a particular type of document. In some embodiments, the instructions can be executed to receive the document from the client. In some embodiments, the instructions can be executed to verify that the received document is the particular type of requested document using artificial intelligence. In some embodiments, the instructions can be executed to provide a notification to the user that the document is accepted, based on verification that the received document is the particular type of requested document.

### BRIEF DESCRIPTION OF THE DRAWINGS

FIG. 1 depicts an example of an environment which can be implemented for servicing a customer account, according to embodiments of the present disclosure.

FIG. 2 depicts a graphical user interface associated with a dashboard, in accordance with embodiments of the present disclosure.

FIG. 3 depicts a graphical user interface associated with a customer tracking dashboard, in accordance with embodiments of the present disclosure.

FIG. 4 depicts a customer specific statistics page, in accordance with embodiments of the present disclosure.

FIG. 5 depicts a detailed application progress page, in accordance with embodiments of the present disclosure.

FIG. 6 depicts a detailed application review progress page, in accordance with embodiments of the present disclosure.

FIG. 7 depicts an architecture for providing a digital platform, in accordance with embodiments of the present disclosure.

FIG. 8 depicts an architecture associated with a decision engine for providing a digital platform, in accordance with embodiments of the present disclosure.

FIG. 9 depicts an artificial intelligence layer, in accordance with embodiments of the present disclosure.

FIG. 10 depicts a flow chart for a questionnaire module, in accordance with embodiments of the present disclosure.

FIG. 11 depicts a method flow diagram for servicing a customer, in accordance with embodiments of the present disclosure.

FIG. 12A depicts a diagram of a system for servicing a customer, according to embodiments of the present disclosure.

FIG. 12B depicts a diagram of an example of a computing device for servicing a customer account according to the present disclosure.

### DETAILED DESCRIPTION

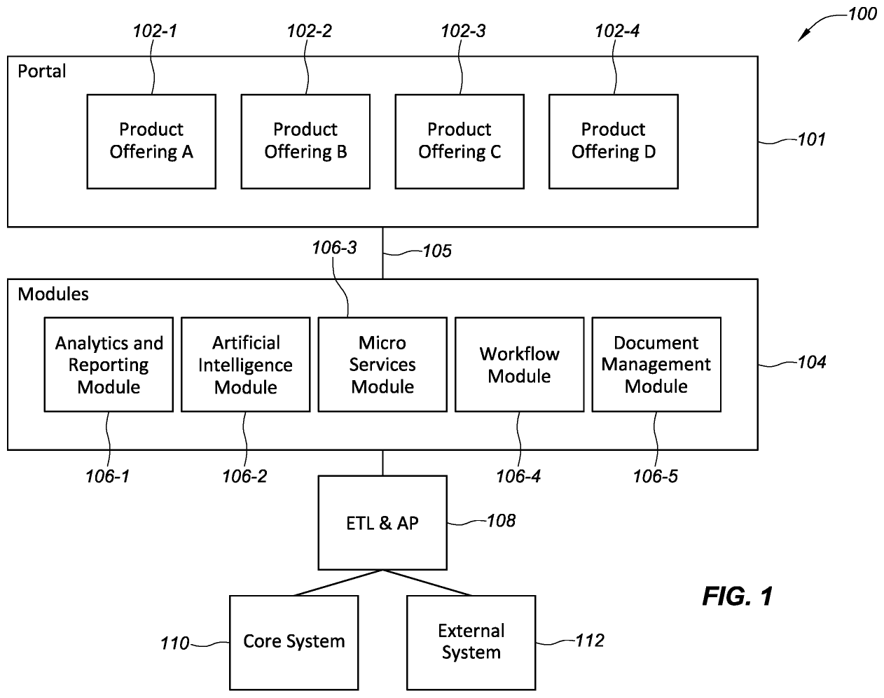

FIG. 1 illustrates a system 100, which can be implemented for servicing a customer account, according to embodiments of the present disclosure. Embodiments of the present disclosure can provide for a method and system that provides for a significantly faster onboarding time for banking customers that are in the cannabis industry. As used herein, client and customer can be used interchangeably. Through use of various embodiments of the present disclosure, onboarding times for customers can be reduced by more than six-fold from approximately six weeks to approximately one week, or even shorter. Additionally, the servicing cost associated with servicing banking customers in the cannabis industry can be reduced by approximately half, if not more. Embodiments of the present disclosure can further allow employees more time to focus on strategic issues, due to the reduction in employee hours needed for servicing this type of customer. In an example, as a result of the incorporation of artificial intelligence into the process, exception based monitoring can be provided to employees, allowing for employees to work on exceptions, thereby reducing employee workload. Embodiments of the present disclosure can result in significant elimination of manual effort needed in handling an account and the handoffs related to different processes associated with opening an account. Additionally, embodiments of the present disclosure can result in improved compliance, risk management and information security as a result of the use of artificial intelligence.

Embodiments of the present disclosure accomplish the above through an integrated end to end system, which allows for singular data entry among all of the traditionally disparate processes involved with servicing a banking customer. For example, in some embodiments, data can be entered into one portion of an application and the data can be populated to other pertinent portions of the application, whereas in prior processes data would need to be rekeyed for disparate applications. A majority of traditionally manual tasks can be eliminated and validation of particular documents can be automated via embodiments of the present disclosure. Monitoring associated with the onboarding and servicing tasks associated with new and existing customers can be more efficient and accurate as a result of a number of user interface dashboards that are made available to a representative. For example, through a convenient user interface, a status and/or statistics associated with one or more accounts and/or account opening processes can be quickly calculated, allowing for review by an employee. Many currently existing processes for servicing a customer account can be fragmented, thus requiring a user to access many disparate systems in order to service a customer (e.g., onboard a potential customer, open a customer account, provide a financial product to a customer, etc.). Embodiments of the present disclosure can enable a user (e.g., representative) to work in a single space that integrates all of the necessary tools that are needed to verify compliance of a potential customer with respect to opening an account and/or providing a financial product to the customer. In some embodiments, potential customer and customer can be used interchangeably.

In some embodiments, the user interface can be a graphical user interface (GUI). The graphical user interface can include hardware components and/or computer-readable instruction components. For instance, hardware components can include input components (e.g., a mouse, a touchscreen, a keyboard, dials and buttons, etc.) and/or output components (e.g., a display, vibration generating devices, speakers, etc.). An example user interface can include a GUI, which can digitally represent data associated with facilitating a transaction. That is, in some examples, an electronic representation can be displayed by a user interface associated with a buyer computing devices 110-1, . . . , 110-N, seller computing devices 112-1, . . . , 112-P, and/or option provider computing devices. Such displays can facilitate interactions between a user and a computer (e.g., allow a user to interact with a computer using images and/or text).

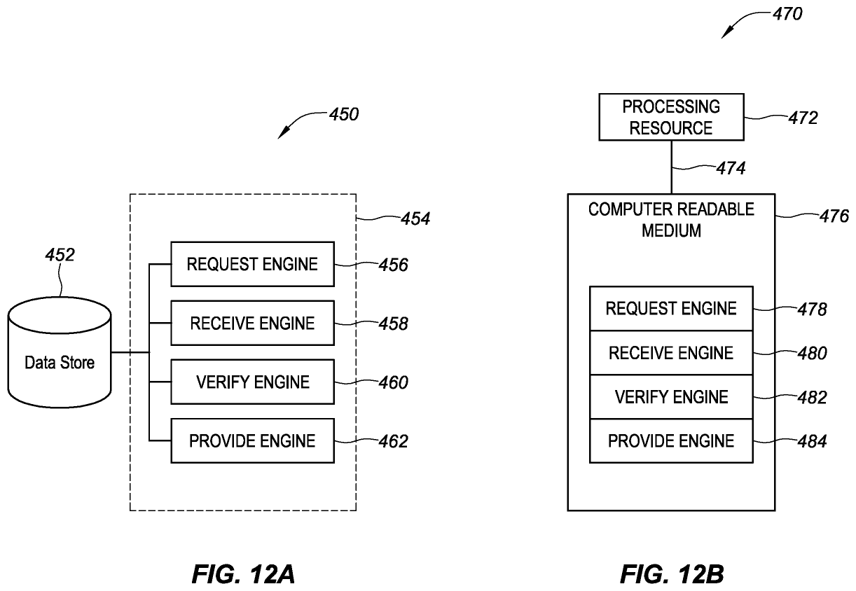

The system 100, as described herein, can represent different combinations of hardware and instructions for servicing a customer account. The system 100 for servicing the customer account can include a computing device, for instance, computing device 470, as discussed in relation to FIG. 12B. The system 100 can be used in the execution of servicing the customer account, as further discussed herein.

In some embodiments, progress and/or work associated with opening or servicing a customer can be captured in one tool, which can be made accessible anywhere. Embodiments of the present disclosure can provide exception based monitoring for employees as a result of the incorporation of artificial intelligence into business processes. For example, generally, the processes for servicing a customer all the way through opening of the customer account to providing services to the customer can be automated via the system, reducing the amount of input needed from a banking representative to points in the process where exceptions occur, such as verification or resolution of exceptions (e.g., problems) occurring with submitted documents, requests for additional information, etc.

Embodiments of the present disclosure can provide for a reactive process with respect to onboarding and/or servicing a customer. For example, based on information provided by the customer, custom fields can be presented to the customer for gathering pertinent information associated with the onboarding and/or servicing of the customer.

In some embodiments the system can be implemented for the servicing and tracking of processes associated with a financial customer. For example, the system can be implemented for any process associated with a financial customer starting with onboarding, to providing financial products to the customer, to tracking of the progress of onboarding and/or the progress associated with providing the financial products to the customer. For example, servicing a financial customer can include onboarding a customer with respect to providing the customer a banking service. In some embodiments, the banking service can be related to providing financial products, which can be related to banking, to a customer associated with the cannabis industry. Although the cannabis industry is discussed in particular, embodiments of the present disclosure can be used with a number of different industries.

In some embodiments, the system can include a portal 101. In an example, the portal 101 can include one or more user interfaces through which a number of different product offerings 102-1, 102-2, 102-3, 102-3 can be accessed, hereinafter referred to in the plural as product offerings 102. Although four product offerings 102 are depicted, the system can include fewer than or greater than four product offerings. In some embodiments one or more of the product offerings A, B, C, D, can include a cannabis banking application layer (e.g., product offering A 102-1). For example, the cannabis banking application layer can in some embodiments provide banking related functionality to cannabis banking customers through a local, regional, national, and/or international bank. In some embodiments, the cannabis banking application can have access to one or more modules 104, which provides the functionality to the product offering. For example, the one or more modules can include, an analytics and reporting module 106-1, an artificial intelligence module 106-2, a micro services module 106-3, a workflow module 106-4, a document management module 106-5. Hereinafter, the modules 106-1, 106-2, 106-3, 106-4, 106-5 are referred to in the plural as modules 106. Although five modules are depicted, fewer than or greater than five modules can be included in the system 100. Depending on the particular function being performed through the one or more product offerings 102 (e.g., cannabis banking application), one or more of the modules 106 can be accessed via a link 105. Link 105 (e.g., local, wide area, regional, or global network) represents a cable, wireless, fiber optic, or remote connection via a telecommunication link, an infrared link, a radio frequency link, and/or other connectors or systems that provide electronic communication. That is, the link 105 can, for example, include a link to an intranet, the Internet, or a combination of both, among other communication interfaces. The link 105 can also include intermediate proxies, for example, an intermediate proxy server (not shown), routers, switches, load balancers, and the like.

In some embodiments, the one or more of the product offerings A, B, C, D, can include a digital lending application layer (e.g., product offering B 102-2). For example, the digital lending application layer can in some embodiments provide digital lending related functionality to cannabis banking customers through local, regional, national, and/or international banks. In some embodiments, the digital lending application can have access to one or more modules 104, which provides the functionality to the product offering. For example, the one or more modules can include, an analytics and reporting module 106-1, an artificial intelligence module 106-2, a micro services module 106-3, a workflow module 106-4, a document management module 106-5. Depending on the particular function being performed through the one or more product offerings 102 (e.g., digital lending application), one or more of the modules 106 can be accessed via the link 105.

In some embodiments, the one or more of the product offerings A, B, C, D, can include a multi-bank system application layer (e.g., product offering C 102-3). For example, the multi-bank system application layer can in some embodiments provide multi-bank access to cannabis banking customers through local, regional, national, and/or international banks, thereby providing for one or more investment opportunities offered by other external banks. In some embodiments, the multi-bank system application can have access to one or more modules 104, which provides the functionality to the product offering. For example, the one or more modules can include, an analytics and reporting module 106-1, an artificial intelligence module 106-2, a micro services module 106-3, a workflow module 106-4, a document management module 106-5. Depending on the particular function being performed through the one or more product offerings 102 (e.g., multi-bank system application), one or more of the modules 106 can be accessed via the link 105.

In some embodiments, the one or more of the product offerings A, B, C, D, can include a real-time payment application layer (e.g., product offering D 102-3). For example, the real-time payment application layer can in some embodiments provide real-time payment functionality to cannabis banking customers. In some embodiments, the real-time payment application can have access to the one or more modules 104, which provides the functionality to the product offering. For example, the one or more modules can include, an analytics and reporting module 106-1, an artificial intelligence module 106-2, a micro services module 106-3, a workflow module 106-4, a document management module 106-5. Depending on the particular function being performed through the one or more product offerings 102 (e.g., real-time payment application), one or more of the modules 106 can be accessed via the link 105.

With reference to the cannabis banking application layer (e.g., product offering A 102-1), some embodiments of the present disclosure can assist with the onboarding of a customer. In the past, such a process was manually driven, for example, direct input was needed from a customer support representative at each stage of the onboarding process. Embodiments of the present disclosure can result in moving the customer support representative's roll to exception based support, rather than hands on support at every stage of the process. For example, the process can start by receiving a request from a customer for a particular financial service (e.g., banking service). In some embodiments, a link can be sent to the potential customer via email, text, etc., such that the potential customer can select the link, which can direct an associated web browser to one or more data intake forms. In some embodiments, the data intake forms can be customizable, based on each particular customer. Such customization can be provided through analyzing customer inputted data and outputting customizable fields, based on a particular characteristic associated with the inputted data provided by the customer. In some embodiments, a reactive response to the information provided by the customer can be generated, based on the characteristic associated with the information. The reactive response to the information can include presenting additional data entry fields and/or prompting the potential customer to enter further information related to the prior information that they entered. Such a reactive response can be custom to each particular customer's entered data. For example, where a first customer enters a first set of data, a first reactive response can be generated with respect to the first set of data. Where a second customer enters a second set of data different from the first customer's set of data, a second reactive response can be generated with respect to the second set of data. The first and second reactive responses can be different from one another, based on the differences associated with the first and second sets of data.

In a particular example, a customer can be prompted to enter information regarding what type of organizational type is associated with their business. In some embodiments, artificial intelligence and machine learning can deliver personalized user experiences based on the customer's unique selected choices and behaviors. The artificial intelligence solution can continue to learn and prompt the customer to enter appropriate related data based on customer responses. The artificial intelligence and machine learning algorithms can automate tasks and deliver experiences that can interpret the information entered by the customer and can determine a particular characteristic associated with the information. Based on the characteristic associated with the information, a particular type of reactive response to the information can be determined. In some embodiments, the reactive response to the information can include presenting a prompt to a user. For example, based on the initial type of information provided by the customer, additional related information can be requested. In some embodiments, the additional related information requested can be requested via a prompt, which requests additional information from the user specific to the determined characteristic.

In an illustrative example, a customer can enter information related to an organization type of their associated company. In an example, the customer can enter information that indicates that their company is a limited liability company. In some embodiments, a list can be presented to the customer and the customer can type the information in a data field. Based on either a selection or inputted information by the customer, a prompt can be provided to the user to upload documentation associated with their limited liability company (LLC) operating agreement. Thus, embodiments of the present disclosure can provide customizable reactive responses, which can be directed at verifying and collecting data associated with information provided by customers via previous data fields and/or selections made by the customer.

In further illustration of the example, upon the customer indicating that their company is an LLC, an input field can be presented to the customer to enter additional information related to their LLC, as mentioned above. In response to the customer entering the additional information related to their LLC, a verification process can be initiated that verifies information entered by the customer. In some embodiments, a request can be provided to the customer to enter documentation related to the prior information provided by the customer. In some embodiments, the system can be trained using artificial intelligence in order to verify the particular type of document that is needed to verify and/or support the previous information provided by the customer.

In accordance with current processes for onboarding customers/servicing customers, many times in response to document requests potential customers upload false documents or documents unrelated to the particular documents being requested. For example, in response to a request to upload an operating agreement for a company, a potential customer may upload an unrelated document in order to comply with the document request. Eventually, a representative of the company onboarding the customer must look at the document to verify that the document is what the customer has purported it to be. This can prove to be a costly process for the company as a result of the time spent in determining that the document does not match what the customer has purported it to be. Embodiments of the present disclosure provide for exception monitoring in such an instance where a customer service representative is notified that the uploaded document does not correspond to what the potential customer has purported it to be. In response to the exception, the system can propose a number of corrective actions to take in order to fix the exception. For example, the customer service representative can choose to have the system make a corrective action, such as reaching out to the potential customer or creating a notification viewable by the potential customer to upload the correct document. In some embodiments, these actions can be provided through a document management module.

As mentioned, some embodiments of the present disclosure can verify the authenticity of the particular document using artificial intelligence. For example, in some embodiments, based on the particular type of document, artificial intelligence can be used to authenticate that the document is the type of document that it is purported to be by the user. For example, where an operating agreement is provided as proof of an LLC, information included in the purported operating agreement can be analyzed using a natural language processing algorithm and the document can be verified based on the analysis. Based on a number of verification points, the document can be authenticated as the type of document it is purported to be by the customer. For example, the purported operating agreement can be analyzed to determine one or more partners to the agreement, an address of the company, a purpose of the company, etc.

Some embodiments of the present disclosure can include extracting data from information uploaded by a customer and applying the data to other portions of an onboarding process. For example, currently, when a customer is onboarded, data needs to be reentered many times in relation to different forms and portions of the onboarding process. Such efforts are duplicative and waste of time for both a customer and a representative that is working to onboard the customer. Accordingly, embodiments of the present disclosure can recognize pertinent information in a document, which can include, addresses, names of individuals, names of companies, etc.

In some embodiments, the pertinent information can be extracted from the document. For example, text in documents associated with an address, name of an individual, names of a company and related text can be copied and automatically entered into related data fields in the onboarding process. For example, the name of an individual or the name of a company included in an operating agreement can be recognized after it has been determined that the operating agreement has been verified. The information (e.g., text in the document) can then be placed into the relevant fields for other onboarding processes. Accordingly, by the time an individual reaches a next onboarding step that requires the similar information, instead of having to reenter the information, the customer can verify the information, thereby reducing an amount of time needed to complete the onboarding process and improving a customer's satisfaction with the onboarding process. In some embodiments, Information Extraction from text data can be achieved by leveraging deep learning and natural language processing techniques to observe, analyze, understand, and/or validate state specific operating documents, including a validity of a licensing expiration date and legal descriptions associated with documents. In some embodiments, an implemented combination of supervised, semi-supervised, and/or unsupervised based text analysis techniques with automatic keyword extraction can create a knowledge library that extracts most important words and expressions from a document that can be uploaded by a customer.

In some embodiments, a document uploaded by a customer can be verified based on the system accessing an external system 112 via the extract, transform, load (ETL) and the application programming interface (API) 108. In an example, particular information in a document can be recognized and the system can access an external system 112 (e.g., third party system) in order to verify that the information is accurate, truthful, and/or up to date.

In some embodiments, the document uploaded by the user can be verified by the system via the artificial intelligence module and through use of an external system. In an example, the artificial intelligence module can extract particular data from the document and recognize the type of data and/or the meaning of the data. For example, the artificial intelligence module can extract an address from the document and make a determination that the extracted information is an address associated with the LLC, which is the subject of the document. In a further example, the artificial intelligence module can extract the names of one or more persons or a date of formation associated with the LLC. In some embodiments, the artificial intelligence module can access the external system 112 and can verify the information extracted from the document. For example, in some embodiments, the artificial intelligence module can access the external system 112 via the ETL & API 108 in order to verify the information extracted from the document. In some embodiments, the external system can be associated with one or more websites based on the type of document being analyzed by the artificial intelligence module. For example, if the document is an operating agreement, a state sponsored website can be accessed to verify the information extracted from the document. In some embodiments, address information can be verified by accessing a database associated with the United States Postal Service, or another type of database associated with addresses of businesses and/or individuals. In some embodiments, the document can include a driver's license and information such as the individual's driver's license number, birth date, expiration date of the license, name, address, etc. can be recognized by the artificial intelligence module 106-2 and can be extracted from an image of the driver's license. In some embodiments, the artificial intelligence module 106-2 can compare the information extracted from the driver's license to information housed on an external system 112. Accordingly, embodiments of the present disclosure can automate the verification of documents without direct intervention by a representative associated with the system. In some embodiments, as previously discussed, intervention by the representative can be limited to exception based monitoring. For example, where the artificial intelligence module encounters a problem with extracting information and/or verifying information obtained from a database (e.g., website) in the verification of the document, the representative can be notified and can intervene in order to provide manual feedback to the system. In some embodiments, the system can be continuously trained based on the feedback that is provided by the representative as a result of exception based monitoring.

Upon entry of all information in the customer onboarding process, in some embodiments, the system 100 can complete a check for any missing and/or incomplete answers. In some embodiments, the system 100 can notify the customer and/or a representative that additional information is required to be entered. Once the system 100 completes a check for missing or additionally required information, the application can be submitted for compliance review. In some embodiments, a representative can be notified that the application is ready for compliance review via an email/text or other notification. In some embodiments, review of the application can begin when the representative accesses a portal to begin review of the application.

In some embodiments, the representative can access the application via the core system 110, which can be a system associated with a bank, in an example. In some embodiments, the application can be loaded into a secure and encrypted data repository, and the representative can access a dashboard in order to review the application. In some embodiments, artificial intelligence can call attention to any exceptions that need attention by the representative. Over time, based on the representative's response to the exceptions, the system can be trained.

In some embodiments, in review of the application, the system 100 can perform further searching on the internet and/or dark web with respect to the applicant and the system 100 can present the information to the representative in the review process. Based on the results of the further internet and/or dark web search, the representative can request input from the customer regarding the additional found information and/or other problems associated with the application. For example, a grower's license uploaded by the customer may be out of date and discovered by the artificial intelligence module and the representative can request that the customer provide an updated valid copy of their grower's license.

In some embodiments, the representative can access data metrics associated with accounts as further discussed herein, which can be provided through an analytics and reporting module. In some embodiments, the user can be presented with a progress report associated with a number of applications that are currently being opened. In some embodiments, the progress associated with overall account openings and/or individual account openings can be represented as a graphical representation that is presented to the representative for ease of reference. In some embodiments, information presented to the user can include the number of existing applications, new leads, total applicants, accounts created, conversion rate, etc. In some embodiments, information can be presented to the representative that includes the name associated with each account, any open issues associated with the account, an expected resolution date associated with each issue, and/or a responsible representative for each account/open issue. Assignment of open issues to particular representatives can be completed through respective portals associated with each employee. In some embodiments, assignment of open issues and/or other account maintenance tasks can be performed via the workflow module 106-4.

In some embodiments, upon approval of the account, a representative can make a selection to create a new account. Information associated with the new account can be sent to the core system 110, which can be a core system associated with a bank in some embodiments. In some embodiments, the customer can be notified that the account has been opened and provided a link to access the account. Further services can be offered to the customer in some embodiments, such as a debit card, checkbook, or other services. In some embodiments, the user can be sent an online ordering catalogue from which they can order the services.

In some embodiments, upon opening of the customer account, ongoing compliance monitoring needs to take place. For example, documents need to be reviewed for expiration dates and/or new documents need to be requested in order to keep the account in compliance. Furthermore, continued searching may need to be performed in order to determine whether problematic information is available via the internet and/or dark web. Some embodiments of the present disclosure can generate reports via a user dashboard, using business intelligence to create such reports and/or dashboards, thereby providing analytics to representatives in order for them to monitor particular accounts.

In some embodiments, the system 100 can be utilize a microservices module 106-3, which can provide for an architecture that can make processes in the system easier to scale and faster to develop. In some embodiments, the use of microservices can contribute to an open architecture associated with the system 100, which can enable an easier integration of the system 100 with third party systems (e.g., external system 112). As a result of the system 100 having an open architecture, the system can communicate with external systems 112 in order to obtain information for the verification of documents.

In some embodiments, one or more other product offerings can be provided by the system, as previously discussed herein. In some embodiments, the product offering can include a digital lending application layer (e.g., product offering B 102-2) configured to provide digital lending products to the customer. Although the above referenced examples with respect to the cannabis banking application layer 102-1 are discussed with respect to onboarding a customer with respect to cannabis banking, the same features can be used for providing digital lending products to the customer, among other products. For example, there can be an application process through which the modules 106-1, 106-2, . . . , 106-5 can provide assistance with respect to providing a digital lending application to a customer. Such a process for providing digital lending products to the customer can involve a customer onboarding as discussed above and use of each one of the modules 106-1, 106-2, . . . , 106-5 in a same or similar fashion as that discussed in relation to the cannabis banking application layer.

In some embodiments, one or more other product offerings can be provided by the system, as previously discussed herein. In some embodiments, the product offering can include a digital lending application layer (e.g., product offering B 102-2) configured to provide digital lending products to the customer. Although the above referenced examples with respect to the cannabis banking application layer 102-1 are discussed with respect to onboarding a customer with respect to cannabis banking, the same features can be used for providing digital lending products to the customer. For example, there can be an application process through which the modules 106-1, 106-2, . . . , 106-5 can provide assistance for providing a digital lending application to a customer. Such a process for providing digital lending products to the customer can involve a customer onboarding as discussed above and use of each one of the modules 106-1, 106-2, . . . , 106-5 in a same or similar fashion as that discussed in relation to the cannabis banking application layer. In some embodiments, information gathered from the customer from the cannabis banking application layer can be gathered and used in an application process for providing the digital lending products. In some embodiments, the system 100 can prepopulate forms required for completion by the customer using the information gathered from the cannabis banking application layer.

In some embodiments, one or more other product offerings can be provided by the system, as previously discussed herein. In some embodiments, the product offering can include a multi-bank system application layer (e.g., product offering C 102-3) configured to provide a customer access to a multi-bank system. Although the above referenced examples with respect to the cannabis banking application layer 102-1 are discussed with respect to onboarding a customer with respect to cannabis banking, the same features can be used for providing a multi-bank system application layer. For example, there can be an application process through which the modules 106-1, 106-2, . . . , 106-5 can provide assistance for providing an application to a multi-bank system to a customer. Such a process for providing the customer access to the multi-bank system can involve a customer onboarding as discussed above and use of each one of the modules 106-1, 106-2, . . . , 106-5 in a same or similar fashion as that discussed in relation to the cannabis banking application layer. In some embodiments, information gathered from the customer from the cannabis banking application layer can be gathered and used in an application process for providing access to the multi-bank system. In some embodiments, the system 100 can prepopulate forms required for completion by the customer using the information gathered from the cannabis banking application layer. In some embodiments, since the account information for the customer is already accessible via the cannabis banking application layer, recommendations with respect to the multi-bank system can be made with respect to the multi-bank system that would maximize a bank's investment returns and optimize liquidity. In some embodiments, the banking application layer can be designed to be a bank product agnostic solution, easily configured and enabled to use others part of financial institutions. The captured information can drive seamless product onboarding, or based on artificial intelligence capabilities, the system could offer additional banking products.

In some embodiments, one or more other product offerings can be provided by the system, as previously discussed herein. In some embodiments, the product offering can include application layers that include one more of an anti-money laundering service and real-time payment application layers (e.g., product offering D 102-4) configured to provide an anti-money laundering service and real-time payment application layer to the customer. Although the above referenced examples with respect to the cannabis banking application layer 102-1 are discussed with respect to onboarding a customer associated with cannabis banking, the same features can be used for providing anti-money laundering service and real-time payment application layers. In some embodiments, an anti-money laundering service can be a key function of banking compliance that must be in place and effective for banks to have marijuana related business customers. In some embodiments, because the customer's data associated with their accounts (e.g., deposits, payments, etc.) is already accessible through the system 100, the anti-money laundering solution can be provided through the system. In some embodiments, the anti-money laundering solution can be a rules-based system where alerts are created when certain transaction conditions occur. The application can configure transaction conditions including customer transactional behavior patterns, any legal ID licensing expiration, and office of foreign assets control/politically exposed person (OFAC/PEP) exceptions. In some embodiments, through one or more dashboards provided by the system, as discussed herein, a representative can monitor alerts, which can be closed if there is no issue or reported as required.

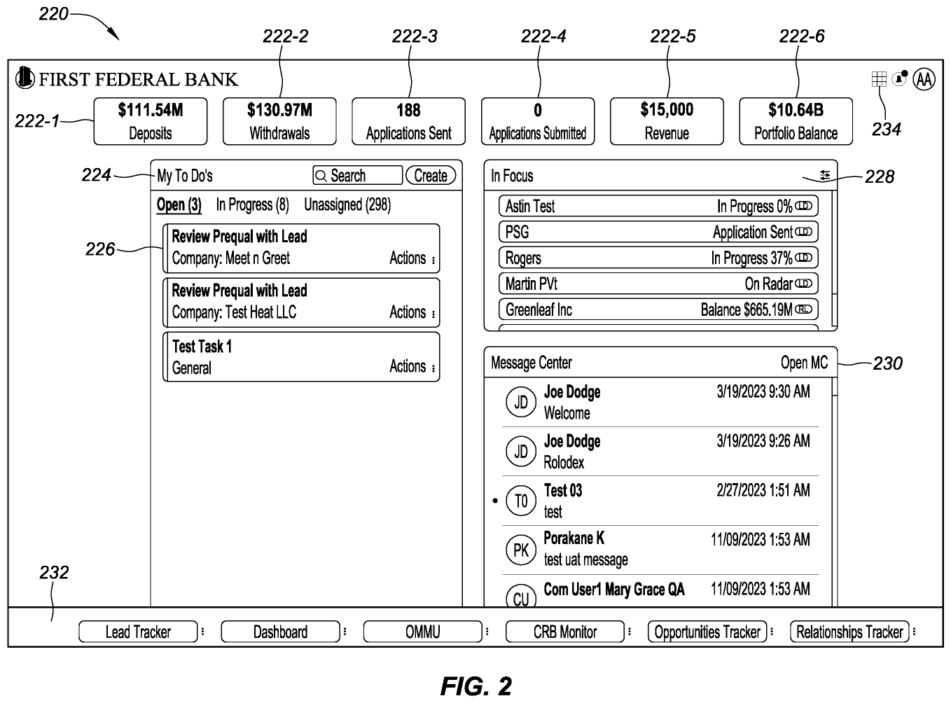

FIG. 2 depicts a graphical user interface associated with a dashboard 220, in accordance with embodiments of the present disclosure. In some embodiments, the dashboard 220 can be accessible to a representative of a financial company, which can include, for example, a bank. In some embodiments, the dashboard can be presented to the user via a graphical user interface displayed on a computing device, such as a personal computer and/or cell phone. In some embodiments, the dashboard 220 can present a number of different metrics to the user. For example, in some embodiments, metric tabs 222-1, 222-2, . . . , 222-6 can be presented to a user. For example, in some embodiments, a deposits metric tab 222-1 can be presented to a user, which can represent a total amount of deposits with a financial institution. In some embodiments, a withdrawals metric tab 222-2 can be presented to a user, which can represent a total amount of withdrawals from a financial institution. In some embodiments, data with respect to applications sent to prospective customers and applications submitted from prospective customers can be provided in application data tabs, which can include applications sent tab 222-3 and applications submitted 222-4 tab. In some embodiments revenue information can be presented to a user in relation to a revenue tab 222-5 and a portfolio balance can be presented to a user via a portfolio balance tab 222-6. In some embodiments, one or more of the tabs 222 can be selectable by a user and can open such that details associated with the information represented by each tab can be expanded. For example, information associated with individual customer deposits, withdrawals, applications, etc. can be presented by selecting one or more of the tabs 222.

In some embodiments, the dashboard can include a task list 224 (e.g., labeled as My To Do's), which can display one or more tasks 226 associated with onboarding and/or servicing a customer and/or potential customer. In some embodiments, each one of the tasks can include a designator, which marks the task as active, inactive, complete, open, in progress, unassigned, etc. In some embodiments, the user can click on each task for further details associated with each task and/or can set reminders associated with the task. In some embodiments, each task can be dragged by the user selecting the task, such that the user can reorder the tasks in relation to their preference and/or priority associated with each task. In some embodiments, a search field can be included, such that a particular task can be searched for.

In some embodiments, a focus tab can be provided, such that particular accounts can be highlighted. In some embodiments, a filter can be associated with the focus tab 228, such that particular accounts meeting the limitations associated with the filter can be displayed in the focus tab. In some embodiments, the filter can be a drop down menu that presents a number of filters that can be selected in order to pair down the number of particular accounts to only those meeting the filter preferences set by the user.

In some embodiments, a message center tab 230 can be provided, which can display messages from customers, potential customers, internal messages with respect to the company, and/or external messages with respect to the company. In some embodiments, the messages can be related to accounts being opened within the company.

In some embodiments, the dashboard can present a number of quick links 232 on the bottom of the dashboard, including a lead tracker, dashboard, link to the office of medical marijuana use (OMMU), credit reference bureau (CRB) monitor, opportunities tracker, and/or relationship tracker. Although particular examples are given with respect to quick links that can be provided on the dashboard, the particular quick links can be customized to a user's preference, including other types of quick links not mentioned herein.

In some embodiments, the dashboard can be reorganized by a user moving different tabs to different locations on the user interface according to the user's preference. For example, in some embodiments, a selection can be made at a reorganization tab 234 to reorganize the tabs and one or more of the tabs can be dragged to a new location on the user interface.

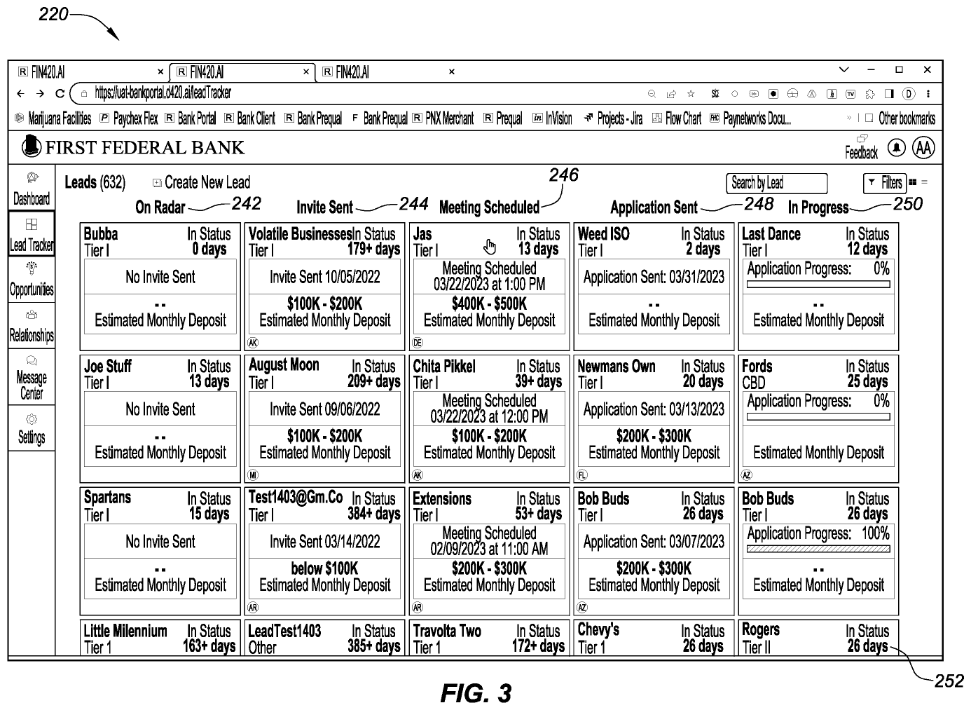

FIG. 3 depicts a graphical user interface associated with a customer tracking dashboard 240, in accordance with embodiments of the present disclosure. In some embodiments, the customer tracking dashboard 240 can include a number of tracking columns 242, 244, . . . , 250 that can be customizable to a user, based on their unique preference. In some embodiments, each of the tracking columns 242, 244, . . . , 250 can list a number of potential accounts, accounts in progress for opening, etc. As depicted, an “On Radar” tracking column 242 can be included to provide a visual representation of potential leads and their status. In some embodiments, an “Invite Sent” tracking column 244 can be included in order to track potential customers to which an invite has been sent. In some embodiments, a “Meeting Scheduled” tracking column 246 can be provided in order to track customers with which a meeting has been scheduled. In some embodiments, an “Application Sent” tracking column 248 can be provided in order to track applications that have been sent to customers. In some embodiments, an “In Progress” tracking column 250 can be provided in order to track applications that are currently in progress. As depicted, an application progress associated with each customer can be displayed in the “In Progress” tracking column 250. In some embodiments, for each customer represented in each tracking column, the customer can be selected and details associated with the customer can be viewed. In some embodiments, the number of columns and/or the subject of each column can be customized by a user.

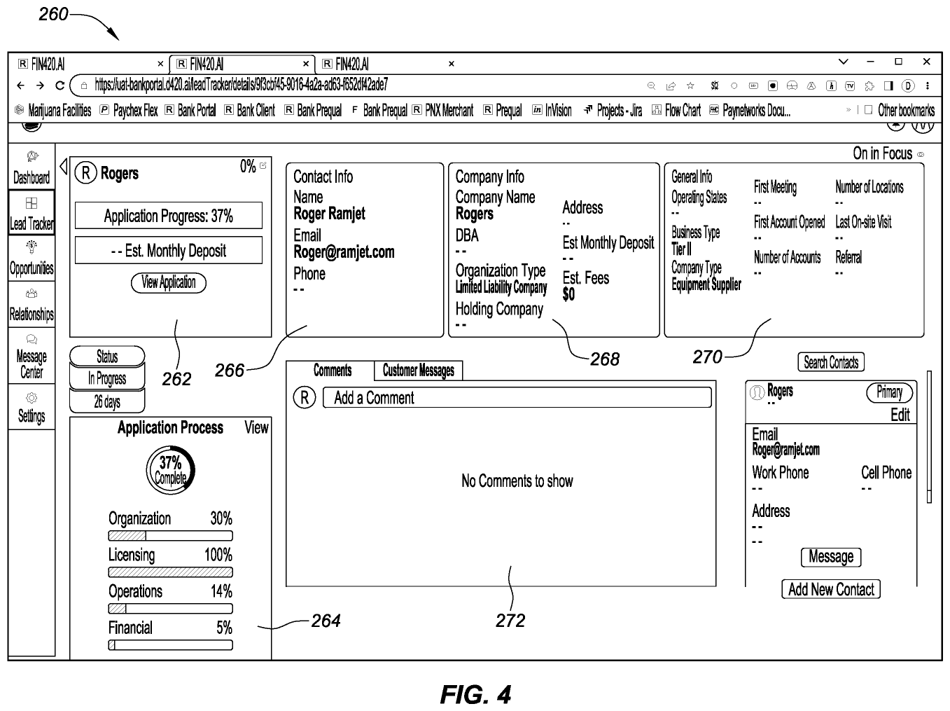

For example, as depicted in FIG. 4, a particular customer (e.g., Rogers) can be selected to open up a detailed customer statistics page 260 showing statistics associated with the customer as depicted in FIG. 4. For example, in some embodiments a particular potential customer or customer's tab 252, as shown in FIG. 3 can be selected and opened to display the detailed customer statistics page 260. In some embodiments, a landing tab 262 can be displayed with a name or other type of indicator that identifies the account. In some embodiments, a nickname can be chosen by a user and displayed on the landing tab 262. In some embodiments, details associated with application progress, estimated monthly deposit, or a selectable icon that can be selected by a user to open up the associated account application and details thereof.

In some embodiments, an application statistics tab 264 can be displayed that provides statistics associated with the overall application progress and further provides statistics associated with each portion of the application, such as organization, licensing, operations, and financial portions of the application. Each one of the statistics associated with the individual portions of the application can be selected to bring a user to a more detailed page, which shows in more detail the portions of each part of the application that are still outstanding. In some embodiments, further customer information can be provided on tabs 266, 268, 270. As further depicted, the customer statistics page can include a message center 272, which can include messages sent and/or received from the client and/or comments made by a user or a team member of the user. In some embodiments, portions of the application process can be flagged or can have notes attached to the particular portion. Each comment or note can have an identifier attached to it, such that the flags/notes can be easily recalled. Some embodiments can allow for the flags/notes to be displayed in the comments section of the message center and/or another area that can be easily accessed by a user. In some embodiments, the organization of the customer statistics page can be adjusted by reorganizing the particular tabs on the page, the position of which is user customizable.

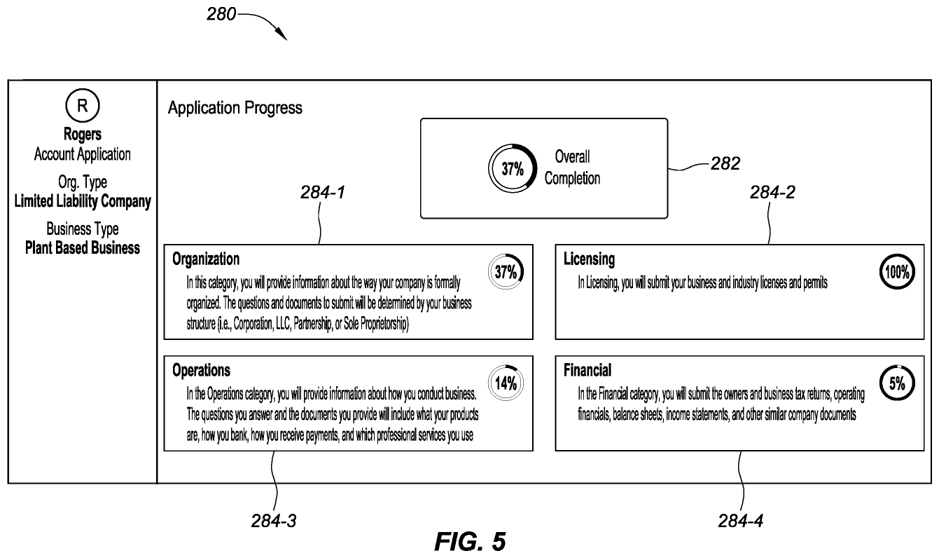

FIG. 5 depicts a detailed application progress page 280, in accordance with embodiments of the present disclosure. In some embodiments, the detailed application progress page 280 can be presented to a user to provide a detailed account of the progress associated with completion of a customer application by the customer. The detailed application progress page 280 can be accessed by selecting an option to view the application progress from the application statistics tab 264, as depicted in FIG. 4. As depicted, the progress associated with completing portions of the application regarding the organization of the customer's business can be displayed in the organization tab 284-1, the progress associated with completing portions of the application regarding the licensing documents associated with the customer's business can be displayed in the licensing tab 284-2; the progress associated with completing portions of the application regarding the operations of the customer's business can be displayed in the operations tab 284-3, the progress associated with completing portions of the application regarding the financial documents associated with the customer's business can be displayed in the financial tab 284-4. As previously discussed, each one of the tabs 284-1, 284-2, 284-3, 284-4 can be selected, such that a detailed accounting associated with the progress in each category of the application can be displayed.

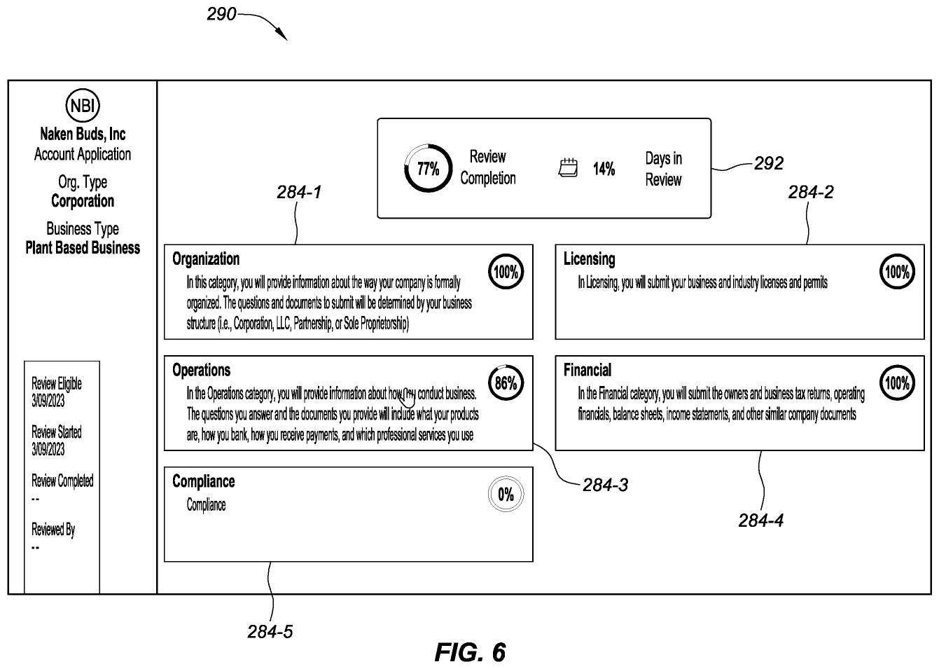

FIG. 6 depicts a detailed application review progress page 290, in accordance with embodiments of the present disclosure. In some embodiments, the detailed application review progress page 290 can provide metrics to a user regarding the progress associated with review of a potential customer's application. In some embodiments, a review summary tab 292 can provide information to a user regarding the overall level of review that has been completed for the application. Further information provided in the review summary tab 292 can include the number of days that the application has been in review. As depicted, a number of tabs associated with the review progress of different portions of the application can be provided. For example, the review progress tabs can include an organization review progress tab 284-1, a licensing review progress tab 284-2, an operations review progress tab 284-3, a financial review progress tab 284-4, and a compliance review progress tab 284-5. In some embodiments, one or more of the progress tabs 284 can be selected in order to provide a more detailed view of the outstanding items associated with each area of the application that needs to be reviewed. As further depicted, in some embodiments, a graphical indicator can be provided for each one of the tabs to indicate a percentage of completion associated with each one of the areas of review. For example, in the review summary tab 292, a total review completion (e.g., 77%) can be displayed to a user, which is representative of the total completion of review of the application and takes into account the level of review completion for each area represented by the individual review progress tabs 284.

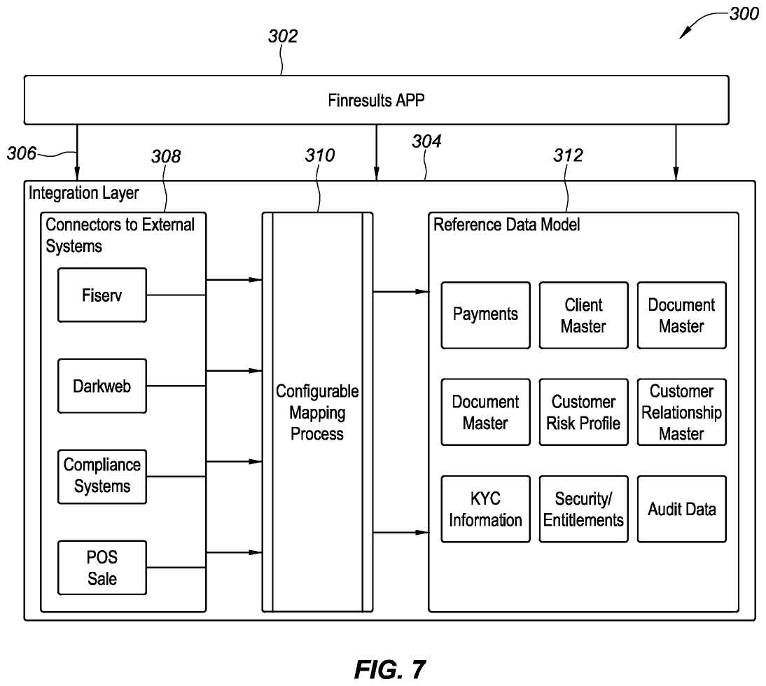

FIG. 7 depicts an architecture for providing a digital platform, in accordance with embodiments of the present disclosure. In some embodiments, the digital platform can be an application provided on a mobile device and/or can be a program that is provided on a computing device. As depicted, an application layer 302 can be provided (e.g., Finresults APP). The application layer 302 can be in communication with an integration layer 304 via one or more links 306. In an example, the application can have an open architecture thus allowing for the application to communicate and coexist with a number of other external systems 308. In an example, data can be gathered and/or sent to external systems via the integration layer 304, allowing for increased functionality of the application layer 302. In an example, the external systems can include systems associated with external financial technology companies, such as Fiserv. In some embodiments, the external systems can include the dark web, such that data can be searched in regards to due diligence efforts associated with potential and/or current customers. In some embodiments, the external systems can include compliance systems [[Please provide an example of a compliance system.]] In some embodiments, the external systems can be a point of sale system (e.g., POS Sale), allowing for information with respect to transactions made by a customer account to be received by the application layer 302.

In some embodiments, a configurable mapping process 310 can allow for the external systems 308 to communicate with a reference data model 312. For example, the mapping process can be configurable to each one of the external systems 308, in order for each one of the external systems to communicate each data model included in the reference data models. In an example, the data models can include data models associated with payments, client master, document master, customer risk profile, customer relationship master, know your client (KYC) information, security/entitlements, audit data, etc.

In some embodiments, the reference data model 312 can host data associated with one or more of the external systems 308. Data can be extracted through batch jobs and/or on demand. In some embodiments, a mapping engine can help to map external data to the reference data model and an integration layer can access the external systems 308 directly.

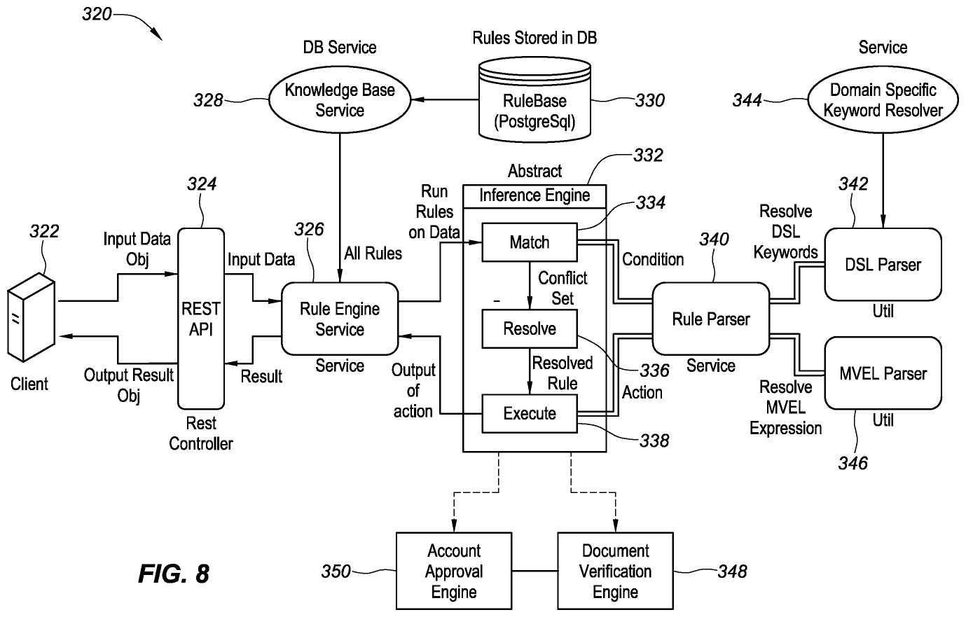

FIG. 8 depicts an architecture associated with a decision engine 320 for providing a digital platform, in accordance with embodiments of the present disclosure. In some embodiments, the decision engine can be utilized with respect to providing customer service and/or an approval process with respect to a loan, insurance, among other types of products, as indicated by the account approval engine 350 and document verification engine 348. In some embodiments, a client computing device 322 can communicate with a rule engine service via a RESTful application programming interface, which can provide a flexibility with respect to different types of data formats. In an example, the client 322 can provide an input data object to the API 324, which can be transformed by the API into input data that is input into a rule engine service 326. The rule engine service 326 can access a knowledge base service, which can have access to a rule storage database 330. The rule engine service 326 can match particular rules with the input data, providing the rule matched data to an inference engine 332. In some embodiments, the inference engine 332 can have access to a rule parser 340, which can evaluate the data in relation to the rules, in order to provide an answer with respect to whether the data is compliant or noncompliant with the rules. In some embodiments, the inference engine can extract particular data from the input data, based on the rules. In order to make such a determination with respect to whether the data is compliant or noncompliant with the rules and/or what data to extract from the input data, the inference engine 332 can have access to a rule parser 340, which can identify particular patterns of text that represent particular characteristics of interest, such as names, addresses, etc. In some embodiments, the rule parser 340 can have access to a DSL parser 342 and an associated domain specific keyword resolver 344, such that DSL keywords can be resolved. In some embodiments, the ruler parser 340 can have access to an MVEL parser 346, such that MVEL expressions can be resolved.

In some embodiments, the inference engine 332 can determine whether the rules run on the data provide a match 334 with respect to the input data. In some embodiments, where a conflict exists with respect to the input data and a rule, the inference engine can resolve the conflict 336. Once the conflict has been resolved 336, the rule can be executed 338 on the input data. In some embodiments, the rules can be run on any number of decision making processes, including an account approval engine 350, document verification engine 348, etc. An output of the inference engine 322 can be provided to the rule service engine 326, which can be provided to the client 322 by the REST API 324.

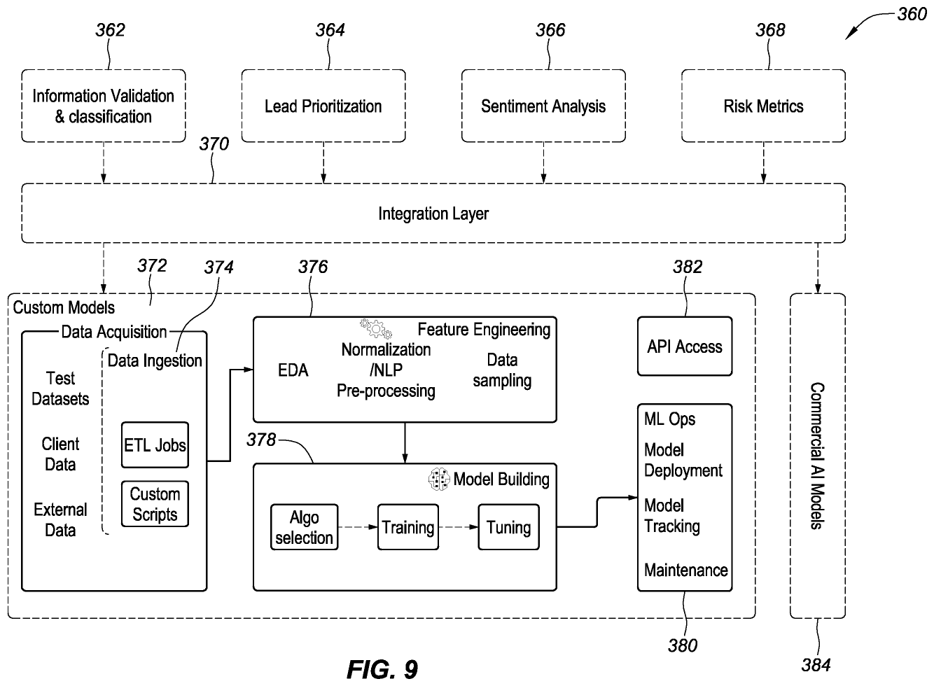

FIG. 9 depicts an artificial intelligence layer, in accordance with embodiments of the present disclosure. In some embodiments, inputs, inputs such as information validation and classification 362, lead prioritization 364, sentiment analysis 366, risk metrics 368 can be provided to a custom artificial intelligence model 372 and/or a commercially available artificial intelligence model 384 via an integration layer 370. In some embodiments, one or more decisions can be made and/or actions can be taken with respect to the inputs 362, 364, . . . , 368 by the custom model 372 or the commercial available model 384. In some embodiments, a commercially available artificial intelligence model such as Google or Microsoft's artificial intelligence model can be utilized. In some embodiments, a custom artificial intelligence model 372 can be trained. In an example, data can be acquired by a data acquisition module 374, which can be used to obtain data that can be used to train the custom artificial intelligence model 372. The data can include data from test datasets, client data, and/or external data. The data can be ingested from the multiple sources into a single storage medium, for example a cloud-based storage medium, and extract, transform, load jobs can be run on the data in order to load the data into a warehousing environment. In some embodiments, custom scripts can be run on the data, as depicted, prior to providing the data to a feature engineering module 376.

In some embodiments, the feature engineering module 376 can extract features from the data through exploratory data analysis (EDA), normalization and natural language processing (NLP), pre-processing and data sampling. In some embodiments, processing the information with the feature engineering module can result in features (e.g., characteristics, attributes, and/or properties) being extracted from the data. The features can be provided to a model building module 378, which can select algorithms, can train a model, and can tune the model, based on the features that are extracted from the data. As mentioned herein, the model can be continuously updated based on new test datasets, new client data, and/or new external data that is provided to the system.

In some embodiments, an end module 380 can provide machine learning operations (ML Ops) to an application programming access module 382. In some embodiments, end module 380 can be responsible for model deployment, model tracking, and/or model maintenance, as well.

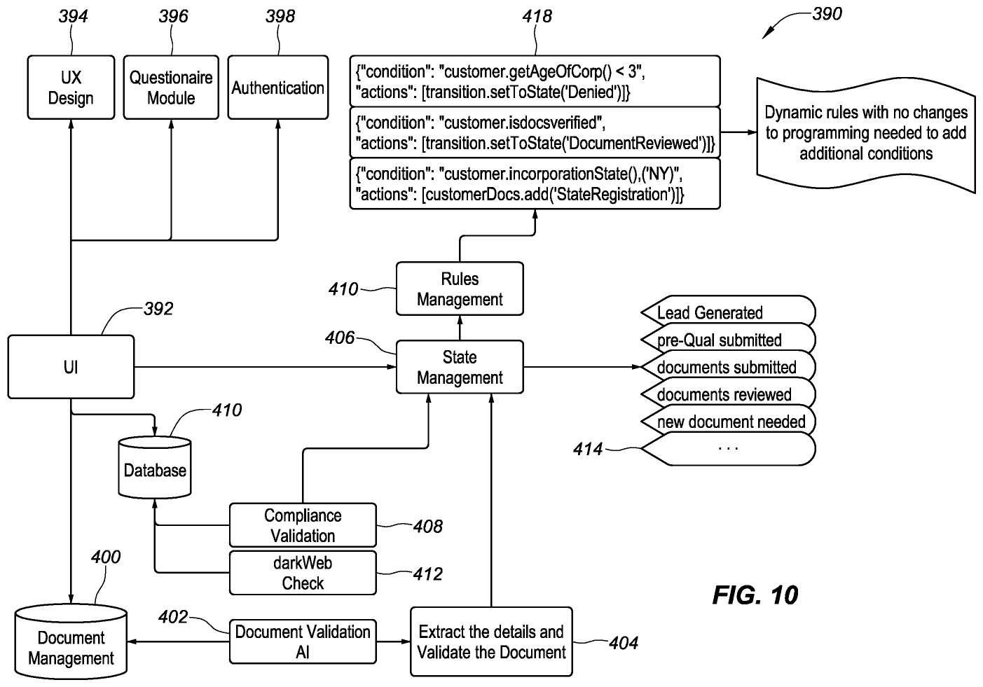

FIG. 10 depicts a flow chart for a questionnaire module 390, in accordance with embodiments of the present disclosure. In some embodiments, the questionnaire module 390 can utilize artificial intelligence. In some embodiments, the questionnaire module 390 can be utilized in the onboarding of a customer with respect to the opening of an account of qualification for a particular product. In some embodiments, a particular set of questions can be provided to a customer based on the type of company associated with the customer. For example, a company can be considered a Tier 1 company that is a cannabis touch company, such as a company responsible for touching plants; a company can be considered a Tier 2 company where greater than 50% of its profits are derived from the cannabis business; and a company can be considered a Tier 3 company where less than 50% of its profits are derived from the cannabis business. In some embodiments of the present disclosure, different sets of questions can be provided to companies based on the types of plants grown (e.g., cannabis, hemp, etc.). Although some embodiments of the present disclosure are directed towards cannabis and plant growing businesses, principles of the present disclosure can be directed towards other types of companies. For example, embodiments of the present disclosure can be directed towards money services groups and the groups can be ranked based on the risk associated with the company; thereby assigning different processes in the onboarding of the businesses, such as asking different questions based on the risk associated with each company.

In an example, in some embodiments, a user interface 392 can be presented to a customer for communication with the client and acquisition of relevant information in the opening of the account and/or qualification for the particular product. In some embodiments, various modules such as a user experience design module 394, questionnaire module 396, and authentication module 398 can be accessed by the user interface in order to provide particular functionality to the potential customer. In some embodiments, documents can be submitted by a potential customer via the user interface 392. The documents can be loaded to a document management module 400 and the documents can be validated by a document validation artificial intelligence module 402. In some embodiments, an extraction module 404 can extract details from the document and can validate various portions of the documents, such as a name, date, address, etc. A state management module 406 can manage an approval process of the potential customer with respect to the account and/or product, based on a compliance validation module 408, which can access information stored in a database 410, which can be information associated with the customer and/or their business. In some embodiments, the compliance validation module 408 can access the results of a darkWeb check module 412, which can access the darkWeb in order to determine whether any nefarious activity associated with and/or stolen information from the potential customer or their associated business is hosted via the darkWeb.

In some embodiments, the state management module 406 can track the progress of an application process and submit prompts 414 to a user, based on analysis of the customer's application based on the compliance validation, darkWeb check, details extracted from the customer's documents, for example. In an example, the prompts can include, for example, lead generated, pre-qualification submitted, documents submitted, documents reviewed, new document needed. In some embodiments, a rules management module 416 can run rules on particular data in order to generate additional questions, which can be provided to a user. For example, based on a customer's inputted data, the data can be analyzed by the rules management module 416 by running one or more rules 418 on the data. For example, based on a state associated with the customer's business, a rule can be run on the data and an additional prompt can be generated to prompt the customer to provide documents associated with the business's incorporation in that state. In some embodiments, dynamic rules can add additional conditions to the rules with no changes to programming needed.

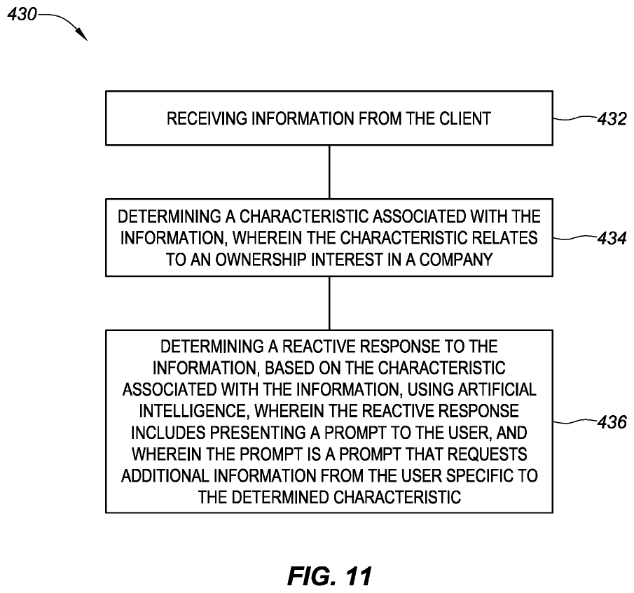

FIG. 11 depicts a method flow diagram 430 for servicing a customer, in accordance with embodiments of the present disclosure. In some embodiments, the method can include receiving information from the client, at step 432. In an example, the information can be related to the customer's name, business name, corporate formation documents, ownership information, etc., as discussed herein. In some embodiments, the method can include determining 434 a characteristic associated with the information. As mentioned, the characteristic can relate to ownership information associated with the company. For example, in response to a prompt provided to the customer, the customer can provide detailed information regarding ownership interests in the company and/or can upload a document that lists the particular ownership interests in the company. In some embodiments, the detailed information regarding the ownership interests in the company and/or the document that lists the particular ownership interests in the company can indicate a proportion of the company owned by one or more parties. For example, the information can list the company ownership as on-half, one-quarter, 30%, 100%, all right, title, and interest, ⅓, ¾, etc. In some embodiments, determining the characteristic associated with the information can include interpreting the information provided by the customer and translating the information into a common value. For example, where a customer provides information regarding the company ownership in one of the above formats, the information can be translated to a common value, such as 0.5, 0.25, 0.3, 1, 1, 0.33, 0.75, respectively, using the above examples. In some embodiments, no such translation may occur and the system makes determinations based on the raw data provided by the user.

In some embodiments, the method can include determining 436 a reactive response to the information. In some embodiments, the information provided by the user can be tabulated to make sure that all ownership interests add up to 100%, for example. In some embodiments where the ownership interest does not add up to 100%, the system can prompt the user to review the provided information and/or provide additional information, such that all ownership interests in the company are provided.

In some embodiments, in response to the ownership interests provided by the customer, for example, based on the ownership interests provided by the customer and/or the names associated with the owners, a prompt can be provided to the user to specify whether one or more of the owners are a publicly owned company. In some embodiments, this prompt can be provided once all ownership information adds up to 100%. Based on the indication of whether the owners are a publicly owned company, further prompts can be provided to the user, such as providing documentation specific to the company or the owner of the company. Such documents can include, for example, articles of incorporation for particular ones of the companies, etc.

In some embodiments, as discussed above, the information can be extracted from a document provided by the customer. In such a case, the extracted information can be loaded into fields presented on a user interface such that the customer can verify that the extracted information is correct. As previously mentioned here, the process can include exception based monitoring, such that a representative can be alerted where an issue exists with, for example extracting information from a submitted document. In an example, where a particular value cannot be determined from the extracted information in a document (e.g., a smudge exists on the document), a prompt can be provided to a representative to evaluate the document and either correct or key in the appropriate value. Based on such input, the system can be further trained as discussed herein.

In an example, the reactive response to the information can be based on the characteristic associated with the information. In some embodiments, the reactive response can include presenting a prompt to the user. The prompt presented to the user can be a prompt that requests additional information from the user, specific to the determined characteristic. For example, in some embodiments where the information entered by the user and/or extracted from a document provided by the user includes information with respect to ownership interests of the company, embodiments of the present disclosure can add the ownership information to determine whether all ownership interest is accounted for (e.g., adds to 100%). In some embodiments, where the ownership information adds to 100%, the system can proceed to a next step, by requesting additional information from the user. In some embodiments, where the ownership information does not add to 100%, the system can request the system request that the user provide additional information to account for all ownership interests.

In some embodiments, the system can request that information be provided for each one of the owners of the company. For example, in some embodiments, prompts can be provided to the customer to indicate whether any of the owners are publicly traded companies, as was done with the original company. A similar process can be followed as previously discussed providing ownership information for each one of the owners, in the case where the owner is a company and/or organization itself.

FIG. 12A depicts a diagram of a system 450 for servicing a customer, according to embodiments of the present disclosure. The system 450 can include a data store 452 (e.g., analogous to database 410 as referenced in FIG. 10), a servicing system 454, and/or a number of engines. The servicing system 454 can be in communication with the data store 452. The purchasing system 454 can include a number of engines (e.g., request engine 456, receive engine 458, verify engine 460, provide engine 462, etc.). The servicing system 454 can include additional or fewer engines than illustrated to perform the various functions described herein. The number of engines can include a combination of hardware and programming to perform a number of functions described herein (e.g., determining a reactive response, determining a characteristic, etc.). Each of the engines can include hardware or a combination of hardware and programming designated or designed to execute a module (e.g., a particular module). The programming can include instructions (e.g., software, firmware, etc.) stored in a memory resource (e.g., computer-readable medium) as well as a hard-wired program (e.g., logic). In some embodiments, the instructions can be method steps that are executed by the processing resource 110 (FIG. 1).

The request engine 456 can include hardware and/or a combination of hardware and programming to request information from a user. In some embodiments, the information requested can include a particular type of document. In some embodiments, the document can be a document associated with a company, a driver's license, passport, etc.

The receive engine 458 can include hardware and/or a combination of hardware and programming to receive the document from the customer. In some embodiments, the document can be uploaded to a data store 452, by the customer.

The verify engine 460 can include hardware and/or a combination of hardware and programming to verify that the received document is the particular type of requested document, using artificial intelligence. In some embodiments, natural language processing can be used to analyze the contents of the document in relation to, for example, a title of the document and/or a label associated with the document. For example, a label associated with a document that is requested from a customer can be analyzed in relation to the contents of the provided document and/or an indication of the type of document provided by the customer, himself, can be analyzed in relation to the contents of the document in order to verify that the document matches the particular type of requested document.

The provide engine 462 can include hardware and/or a combination of hardware and programming to provide a notification to the user that the document is accepted, based on verification that the received document is the particular type of requested document. In some embodiments, the notification of acceptance of the document can be provided to the user via a user interface.

In some embodiments, the contents of the document can be verified by accessing an external database, as discussed herein. For example, with respect to organizational documents associated with a company, a state sponsored database can be accessed. With respect to, for example, a driver's license and/or passport, a state sponsored department of motor vehicles or federally sponsored database can be accessed. In some embodiments, the contents of the document can be compared to the contents of the database to verify the contents of the document. In some embodiments, the document can be verified with respect to its validity, based on the contents of the document matching information included in the external database.

In some embodiments, a determination can be made with respect to an expiration date of the document, based on accessing information included in the external database. In an example, a determination can be made that the document is one of expired or unexpired based on accessing information included in the external database.

FIG. 12B depicts a diagram of an example of a computing device 470 for servicing a client account according to the present disclosure. The computing device 470 can utilize software, hardware, firmware, and/or logic to perform a number of functions described herein.

The computing device 470 can be a combination of hardware and instructions to share information. The hardware, for example can include a processing resource 472 and/or a memory resource 476 (e.g., computer-readable medium (CRM), database, etc.). A processing resource 472, as used herein, can include a number of processors capable of executing instructions stored by the memory resource 476. Processing resource 472 can be integrated in a single device or distributed across multiple devices. The instructions (e.g., computer-readable instructions (CRI)) can include instructions stored on the memory resource 476 and executable by the processing resource 472 to implement a desired function (e.g., provide a notification, etc.).

The memory resource 476 can be in communication with the processing resource 472. The memory resource, as used herein, can include a number of memory components capable of storing instructions that can be executed by the processing resource 472. Such memory resource 476 can be a non-transitory CRM. Memory resource 476 can be integrated in a single device or distributed across multiple devices. Further, memory resource 476 can be fully or partially integrated in the same device as processing resource 472 or it can be separate but accessible to that device and processing resource 472. Thus, it is noted that the computing device 470 can be implemented on a support device and/or a collection of support devices, on a mobile device and/or a collection of mobile devices, and/or a combination of the support devices and the mobile devices.

The memory 476 can be in communication with the processing resource 472 via a communication link 474 (e.g., path). The communication link 474 can be local or remote to a computing device associated with the processing resource 472. Examples of a local communication link 474 can include an electronic bus internal to a computing device where the memory resource 476 is one of a volatile, non-volatile, fixed, and/or removable storage medium in communication with the processing resource 472 via the electronic bus.

The memory resource 476 can include a number of modules such as a request module 478, a receive module 480, a verify module 482, and a provide module 484. The number of modules 478, 480, 482, 484 can include CRI that when executed by the processing resource 472 can perform a number of functions. The number of modules 478, 480, 482, 484 can be sub-modules of other modules. For example, the request module 478 and the receive module 480 can be sub-modules and/or contained within the same computing device. In another example, the number of modules 478, 480, 482, 484 can comprise individual modules at separate and distinct locations (e.g., CRM, etc.).

Each of the number of modules 478, 480, 482, 484 can include instructions that when executed by the processing resource 472 can function as a corresponding engine as described herein. For example, the provide module 484 can include CRI that when executed by the processing resource 472 can function as the provide engine 462. For instance, the provide module 484 can include CRI that when executed by the processing resource 472 can cause a computing device to provide a notification to the user that the document is accepted, based on verification that the received document is the particular type of requested document.

Embodiments are described herein of various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or “in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although at least one embodiment for a system and method for providing a system architecture for a digital platform has been described above with a certain degree of particularity, those skilled in the art could make numerous alterations to the disclosed embodiments without departing from the spirit or scope of this disclosure. Joinder references (e.g., affixed, attached, coupled, connected, and the like) are to be construed broadly and can include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting. Changes in detail or structure can be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A method for servicing a client account, comprising:
receiving information from the client;
determining a characteristic associated with the information; and
determining a reactive response to the information, based on the characteristic associated with the information, using artificial intelligence, wherein the reactive response includes presenting a prompt to the user, and wherein the prompt is a prompt that requests additional information from the user specific to the determined characteristic.

2. The method of claim 1, further comprising receiving a document from the client, wherein the document from the client is received in response to the prompt presented to the user.

3. The method of claim 2, further comprising making a determination with respect to the document provided from the client.

4. The method of claim 3, wherein the determination with respect to the document includes authenticating the document based on a type of document associated with the prompt presented to the user.

5. The method of claim 3, wherein the determination with respect to the document includes determining a validity of information included in the document.

6. The method of claim 5, wherein the validity of information included in the document is determined through accessing a third party database.

7. The method of claim 3, wherein making the determination includes:
making a determination that a problem exists with the document provided, and
providing a list of corrective actions to a representative in response to a determination that the problem exists with the document provided.

8. The method of claim 3, wherein the method further includes:
extracting information from the document, and
entering the extracted information into an additional step associated with the servicing of the client account.

9. A method for servicing a client account, comprising:
receiving information from the client;
determining a characteristic associated with the information, wherein the characteristic relates to an ownership interest in a company; and
determining a reactive response to the information, based on the characteristic associated with the information, using artificial intelligence, wherein the reactive response includes presenting a prompt to the user, and wherein the prompt is a prompt that requests additional information from the user specific to the determined characteristic.

10. The method of claim 9, wherein the additional information includes information related to a type of the company.

11. The method of claim 9, wherein the additional information relates to a percentage ownership interest for a number of parties holding an ownership interest in the company.

12. The method of claim 11, further comprising verifying that the percentage ownership interests equals a particular amount.

13. The method of claim 9, wherein the additional information relates to whether the company or an owner of the company is a publicly traded company.

14. The method of claim 13, further comprising presenting the client with a request for documentation specific to the company or the owner of the company.

15. A non-transitory computer-readable medium storing instructions to service a client account, executable by a processing resource to:
request information from a user, wherein the information requested includes a particular type of document;
receive the document from the client;
verify that the received document is the particular type of requested document using artificial intelligence; and
provide a notification to the user that the document is accepted, based on verification that the received document is the particular type of requested document.

16. The non-transitory computer-readable medium of claim 15, further comprising instructions executable to verify the contents of the document, through accessing an external database.

17. The non-transitory computer-readable medium of claim 16, further comprising instructions executable to verify that the document is valid based on the contents of the document matching information included in the external database.

18. The non-transitory computer-readable medium of claim 16, further comprising instructions to determine that the document is unexpired by accessing information included in the external database.
